(19) United States
(12) Patent Application Publication
(10) Pub. No.: US 2023/0207833 A1
(43) Pub. Date: Jun. 29, 2023

(54) LITHIUM-ION CELL WITH HIGH SPECIFIC ENERGY DENSITY

(71) Applicant: VARTA Microbattery GmbH, Ellwangen Jagst (DE)

(72) Inventors: Edward PYTLIK, Ellwangen (DE); Michael GOTTSCHALK, Aalen (DE); David ENSLING, Ellwangen (DE); Martin ELMER, Ellwangen (DE)

(21) Appl. No.: 17/999,935

(22) PCT Filed: May 17, 2021
(86) PCT No.: PCT/EP2021/062990

§ 371 Date: Nov. 28, 2022

(30) Foreign Application Priority Data
May 29, 2020 (EP) 20177371.0

(51) Int. Cl. H01M 4/75; H01M 10/0525; H01M 4/66; H01M 10/04

(52) U.S. Cl. CPC H01M 4/75; H01M 10/0525; H01M 4/661; H01M 10/0431

(57) ABSTRACT

A lithium ion cell includes a ribbon-shaped electrode-separator assembly comprising an anode, a separator. The electrode-separator assembly is formed as a winding. The anode comprises, as an anode current collector, a ribbon-shaped metal foil having a first longitudinal edge. The anode current collector has a strip-shaped main region loaded with a layer of negative electrode material and a free edge strip extending along the first longitudinal edge that is not loaded with the negative electrode material. The cathode comprises, as a cathode current collector, a ribbon-shaped metal foil having a first longitudinal edge. The cathode current collector has a strip-shaped main region loaded with a layer of positive electrode material and a free edge strip extending along the first longitudinal edge that is not loaded with the positive electrode material. The strip-shaped main region of the anode current collector or the cathode current collector has a plurality of apertures.

### CROSS REFERENCE TO RELATED APPLICATIONS

This application is a U.S. National Phase application under 35 U.S.C. § 371 of International Application No. PCT/EP2021/062990, filed on May 17, 2021, and claims benefit to European Patent Application No. EP 20177371.0, filed on May 29, 2020. The International Application was published in German on Dec. 2, 2021 as WO 2021/239490 under PCT Article 21(2).

### FIELD

The disclosure relates to a lithium-ion cell comprising a ribbon-shaped electrode-separator assembly in the form of a winding.

### BACKGROUND

Electrochemical cells are capable of converting stored chemical energy into electrical energy by virtue of a redox-reaction. They generally comprise a positive and a negative electrode separated by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is ensured by an ion-conducting electrolyte.

If the discharge is reversible, i.e. if it is possible to reverse the conversion of chemical energy into electrical energy that took place during the discharge and thus to charge the cell again, this is said to be a secondary cell. The designation of the negative electrode as anode and the designation of the positive electrode as cathode, which is generally used for secondary cells, refers to the discharge function of the electrochemical cell.

The widely used secondary lithium-ion cells are based on the use of lithium, which can migrate between the electrodes of the cell in ionic form. Lithium-ion cells are characterized by a comparatively high energy density. The negative electrode and the positive electrode of a lithium-ion cell are generally formed by so-called composite electrodes, which comprise electrochemically active components as well as electrochemically inactive components.

In principle, all materials that can absorb and release lithium ions can be used as electrochemically active components (active materials) for secondary lithium-ion cells. Carbon-based particles, such as graphitic carbon, are often used for the negative electrode. Other, non-graphitic carbon materials that are suitable for the intercalation of lithium can also be used. In addition, metallic and semi-metallic materials that are alloyable with lithium can also be used. For example, the elements tin, aluminum, antimony and silicon can form intermetallic phases with lithium. For example, lithium cobalt oxide (LiCoO2), lithium manganese oxide (LiMn2O4), lithium titanate (Li4Ti5O12) or lithium iron phosphate (LiFePO4) or derivatives thereof can be used as active materials for the positive electrode. The electrochemically active materials are generally contained in particle form in the electrodes.

As electrochemically inactive components, the composite electrodes generally comprise a flat and/or strip-shaped current collector, for example a metallic foil, coated with an active material. For example, the current collector for the negative electrode (anode current collector) may be formed of copper or nickel, and the current collector for the positive electrode (cathode current collector) may be formed of aluminum, for example. Furthermore, the electrodes can comprise an electrode binder (e.g., polyvinylidene fluoride (PVDF) or another polymer, for example carboxymethyl cellulose). This ensures the mechanical stability of the electrodes and often the adhesion of the active material to the current collectors. Furthermore, the electrodes may contain conductivity-improving additives and other additives.

As electrolytes, lithium-ion cells generally comprise solutions of lithium salts such as lithium hexafluorophosphate (LiPF6) in organic solvents (e.g., ethers and esters of carbonic acid).

During the manufacture of a lithium-ion cell, the composite electrodes are combined with one or more separators to form an assembly. In most cases, the electrodes and separators are joined together by lamination or bonding. The basic functionality of the cell can then be established by impregnating the composite with the electrolyte.

In many cells, the assembly is formed flat so that multiple assemblies can be stacked flat on top of each other. Frequently, however, the assembly is produced as a winding or processed into a winding.

Generally, the assembly, whether wound or not, comprises the sequence positive electrode/separator/negative electrode. Often, assemblies are manufactured as so-called bicelles with the possible sequences negative electrode/separator/positive electrode/separator/negative electrode or positive electrode/separator/negative electrode/separator/positive electrode.

For applications in the automotive sector, for e-bikes or also for other applications with high energy requirements, such as in tools, lithium-ion cells with the highest possible energy density are needed that are also capable of being loaded with high currents during charging and discharging. Such cells are described, for example, in WO 2017/215900 A1.

Cells for the applications mentioned are often designed as cylindrical round cells, for example with the form factor 21×70 (diameter*height in mm) Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

### SUMMARY

In an embodiment, the present disclosure provides a lithium ion cell. The lithium ion cell includes a ribbon-shaped electrode-separator assembly comprising an anode, a separator, and a cathode in a sequence anode/separator/cathode, the electrode-separator assembly being formed as a winding with two terminal end faces. The anode comprises, as an anode current collector, a ribbon-shaped metal foil having a thickness in a range of 4 μm to 30 μm, a first longitudinal edge, a second longitudinal edge, and two ends. The anode current collector has a strip-shaped main region loaded with a layer of negative electrode material and a free edge strip extending along the first longitudinal edge that is not loaded with the negative electrode material. The cathode comprises, as a cathode current collector, a ribbon-shaped metal foil having a thickness in a range of 4 μm to 30 μm, a first longitudinal edge, a second longitudinal edge, and two ends. The cathode current collector has a strip-shaped main region loaded with a layer of positive electrode material and a free edge strip extending along the first longitudinal edge that is not loaded with the positive electrode material. The anode and the cathode are formed and/or arranged relative to each other within the electrode-separator assembly such that the first longitudinal edge of the anode current collector protrudes from one of the terminal end faces of the winding and the first longitudinal edge of the cathode current collector protrudes from the other of the terminal end faces of the winding. A contact sheet metal member in direct contact with a respective longitudinal edge, the respective longitudinal edge being the first longitudinal edge of the anode current collector or the first longitudinal edge of the cathode current collector, the contact sheet metal member being connected to the respective longitudinal edge by welding. The strip-shaped main region of the current collector connected to the contact sheet metal member by welding has a plurality of apertures.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a sectional view of a possible embodiment of a cell;

FIG. 2 a top view of a current collector in an embodiment;

FIG. 3 a sectional view of the current collector shown in FIG. 2;

FIG. 4 a top view of an anode that can be processed into an electrode-separator assembly in the form of a winding;

FIG. 5 a sectional view of the anode shown in FIG. 4;

FIG. 6 a top view of an electrode-separator assembly fabricated using the anode shown in FIG. 4; and

FIG. 7 a sectional view of the electrode-separator assembly shown in FIG. 6.

### DETAILED DESCRIPTION

There are other factors to consider in the development of improved lithium-ion cells than just energy density. Extremely important parameters are also the internal resistance of the cells, which should be kept as low as possible to reduce power losses during charging and discharging, and the thermal connection of the electrodes, which can be essential for temperature regulation of the cell. These parameters are also very important for cylindrical round cells that contain a composite assembly in the form of a winding. During fast charging of cells, heat accumulation can occur in the cells due to power losses, which can lead to massive thermo-mechanical stresses and subsequently to deformation and damage of the cell structure. The risk is increased if the electrical connection of the current collectors is made via separate electrical conductor tabs welded to the current collectors, which protrude axially from wound assemblies, as heating can occur locally at these conductor tabs under heavy loads during charging or discharging.

The present disclosure provides lithium-ion cells which are characterized by improved energy density compared to prior art and which at the same time have excellent characteristics with respect to their internal resistance and passive heat dissipation capabilities.

The disclosure provides a lithium-ion cell including the following features a. to i.:

a. The cell comprises a ribbon-shaped electrode-separator assembly with the sequence anode/separator/cathode.

b. The anode comprises as anode current collector a ribbon-shaped metal foil with a thickness in the range of 4 μm to 30 μm and with a first and a second longitudinal edge and two ends.

c. The anode current collector has a strip-shaped main region loaded with a layer of negative electrode material and a free edge strip extending along the first longitudinal edge that is not loaded with the electrode material.

d. The cathode comprises, as the cathode current collector, a ribbon-shaped metal foil having a thickness in the range of 4 μm to 30 μm and having first and second longitudinal edges and two ends.

e. The cathode current collector has a strip-shaped main region loaded with a layer of positive electrode material and a free edge strip extending along the first longitudinal edge that is not loaded with the electrode material.

f. The electrode-separator assembly is in the form of a winding with two terminal end faces.

g. The anode and the cathode are formed and/or arranged relative to each other within the electrode-separator assembly such that the first longitudinal edge of the anode current collector protrudes from one of the terminal end faces and the first longitudinal edge of the cathode current collector protrudes from the other of the terminal end faces.

h. The cell has a contact sheet metal member that is in direct contact with one of the first longitudinal edges.

i. The contact sheet metal member is connected to this longitudinal edge by welding.

The current collectors have the function of electrically contacting electrochemically active components contained in the electrode material over as large an area as possible. Suitable metals for the anode current collector include copper or nickel or other electrically conductive materials, in particular copper and nickel alloys or nickel-coated metals. Stainless steel foils are also generally suitable. Suitable metals for the cathode current collector include aluminum or other electrically conductive materials, in particular aluminum alloys.

The current collectors are preferably loaded on both sides with the respective electrode material.

In the free edge strips, the metal of the respective current collector is free of the respective electrode material. Preferably, the metal of the respective current collector is uncovered there so that it is available for electrical contacting, for example by welding.

However, in some embodiments, the metal of the respective current collector in the free edge strips may be coated with a support material that is more thermally resistant than the current collector coated therewith.

“Thermally more resistant” in this context is intended to mean that the support material retains a solid state at a temperature at which the metal of the current collector melts. It therefore either has a higher melting point than the metal or it sublimates or decomposes only at a temperature at which the metal has already melted.

Preferably, both the anode current collector and the cathode current collector each have at least one free edge strip that is not loaded with the respective electrode material. In a further development, it is preferred that both the at least one free edge strip of the anode current collector and the at least one free edge strip of the cathode current collector are coated with the support material. Particularly preferably, the same support material is used for each of the regions.

The support material which can be used can in principle be a metal or a metal alloy, provided that this or these has a higher melting point than the metal from which the surface coated with the support material consists of In many embodiments, however, the lithium-ion cell according to the disclosure is preferably characterized by at least one of the immediately following additional features a. to d.:

a. The support material is a non-metallic material.

b. The support material is an electrically insulating material.

c. The non-metallic material is a ceramic material, a glass-ceramic material or a glass.

d. The ceramic material is aluminum oxide (Al₂O₃), titanium oxide (TiO₂), titanium nitride (TiN), titanium aluminum nitride (TiAlN) or titanium carbonitride (TiCN).

The support material is particularly preferably formed according to the immediately preceding feature b. and especially preferably according to the immediately preceding feature d.

The term ceramic material is to be understood broadly in this context. In particular, it includes carbides, nitrides, oxides, silicides or mixtures and derivatives of these compounds.

By the term “glass-ceramic material” is meant especially a material comprising crystalline particles embedded in an amorphous glass phase.

The term “glass” basically means any inorganic glass that meets the thermal stability criteria defined above and that is chemically stable to any electrolyte that may be present in the cell.

Particularly preferably, the anode current collector consists of copper or a copper alloy while at the same time the cathode current collector consists of aluminum, or an aluminum alloy and the support material is aluminum oxide or titanium oxide.

It may be further preferred that free edge strips of the anode and/or cathode current collector are coated with a strip of the support material.

Preferably, the strip-shaped main regions of the anode current collector and cathode current collector extend parallel to the respective longitudinal edges of the current collectors. Preferably, the strip-shaped main regions extend over at least 90%, particularly preferably over at least 95%, of the areas of the anode current collector and cathode current collector.

In some preferred embodiments, the support material is applied adjacent to the strip-shaped main regions but does not completely cover the free regions in the process. For example, it is applied in the form of a strip or line along a longitudinal edge of the anode and/or cathode current collector so that it only partially covers the respective edge strip. Directly along this longitudinal edge, an elongated section of the free edge strip can remain uncovered.

Particularly preferably, the lithium-ion cell according to the disclosure is a secondary lithium-ion cell.

Basically, all electrode materials known for lithium-ion cells can be used for the anode and cathode.

In the negative electrode, carbon-based particles such as graphitic carbon or non-graphitic carbon materials capable of intercalating lithium, preferably also in particle form, are preferred as active materials. Lithium titanate (Li₄Ti₅O₁₂) is also suitable as an active material. Alternatively or additionally, metallic and semi-metallic materials that are alloyable with lithium can also be used, for example using the elements tin, antimony and silicon, which are capable of forming intermetallic phases with lithium. These materials are also preferably used in particle form.

For the positive electrode, lithium metal oxide compounds and lithium metal phosphate compounds such as LiCoO₂ and LiFePO₄ can be considered as active materials. Furthermore, lithium nickel manganese cobalt oxide (NMC) with the chemical formula LiNiₓMn_{y}Co_{z}O₂(where x+y+z is typically 1) is particularly well suited, Lithium manganese spinel (LMO) with the chemical formula LiMn₂O₄, or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89} O₂ or Li₁₊ₓM—O compounds and/or mixtures of said materials can also be used.

As electrochemically inactive components, the electrode materials may include, for example, an electrode binder and a conductive agent. The particulate active materials are preferably embedded in a matrix of the electrode binder, with adjacent particles in the matrix preferably being in direct contact with each other. Conducting agents have the function of increasing the electrical conductivity of the electrodes. Common electrode binders are based, for example, on polyvinylidene fluoride, polyacrylate or carboxymethyl cellulose. Common conductive agents are carbon black and metal powder.

Furthermore, the cell preferably comprises an electrolyte, in particular based on at least one lithium salt such as lithium hexafluorophosphate dissolved in an organic solvent (e.g. in a mixture of organic carbonates).

The separator is, for example, an electrically insulating plastic film that can be penetrated by the electrolyte, for example because it has micropores. The film can be formed, for example, from a polyolefin or from a polyether ketone. Nonwovens and fabrics made from such plastic materials can also be used as separators.

In addition to the elements mentioned, the lithium-ion cell according to the disclosure also comprises a housing which encloses the electrode-separator assembly in the form of a winding, preferably in a gas-tight and/or liquid-tight manner.

The housing generally comprises a cylindrical housing shell as well as a circular upper part and a circular lower part. For example, the housing can comprise a cup-shaped first housing part, the bottom of which corresponds to the circular lower part, and a circular lid as the second housing part, which serves to close the first housing part. Usually, the two housing parts are separated from each other by an electrically insulating seal. The housing parts may consist of, for example, a nickel-plated sheet steel or a similar metallic material.

The electrode-separator assembly is preferably in the form of a cylindrical winding. Providing the electrodes in the form of such a winding allows particularly advantageous use of space in cylindrical housings. The housing is therefore also cylindrical in preferred embodiments.

In embodiments of disclosure, the lithium-ion cell is particularly characterized by the immediately following feature j.:

j . the strip-shaped main region of the current collector connected to the contact sheet metal member by welding has a plurality of apertures.

The plurality of apertures results in a reduced volume and also reduced weight of the current collector. This makes it possible to introduce more active material into the cell and thus drastically increase the energy density of the cell. Energy density increases up to the double-digit percentage range can be achieved in this way.

In particularly preferred embodiments, the cell according to the disclosure is characterized by at least one of the features a. and b. immediately below:

a. The apertures in the main area are round or square holes, especially punched or drilled holes.

b. The current collector connected to the contact sheet metal member by welding is perforated in the main area, in particular by round hole or slotted hole perforation.

In some preferred embodiments, the apertures are introduced into the strip-shaped main region by laser.

In principle, the geometry of the apertures is not essential. What is important is that as a result of the insertion of the apertures, the mass of the current collector is reduced and there is more space for active material, since the apertures can be filled with the active material.

On the other hand, it can be very advantageous to ensure that the maximum diameter of the apertures is not too large when inserting them. Preferably, the apertures should not be more than twice the thickness of the layer of electrode material on the respective current collector.

In particularly preferred embodiments, the cell according to the disclosure is characterized by the feature a. immediately below:

a. The apertures in the current collector, especially in the main region, have diameters in the range of 1 μm to 3000 μm.

Within this preferred range, diameters in the range from 10 μm to 2000 μm, preferably from 10 μm to 1000 μm, especially from 50 μm to 250 μm, are further preferred.

Particularly preferably, the cell according to the disclosure is further characterized by at least one of the immediately following features a. and b.:

a. The current collector connected to the contact sheet metal member by welding has a lower weight per unit area than the free edge strip of the same current collector, at least in a partial section of the main area.

b. The current collector connected to the contact sheet metal member by welding has no or fewer apertures per unit area in the free edge strip than in the main area.

It is particularly preferred that the immediately preceding features a. and b. are realized in combination with each other.

The free edge strips of the anode and cathode current collector bound the main area toward the first longitudinal edges. Preferably, the anode and cathode current collectors comprise free edge strips along their respective longitudinal edges.

The apertures characterize the main area. In other words, the boundary between the main area and the free edge strip(s) corresponds to a transition between areas with and without apertures.

The apertures are preferably distributed substantially evenly over the main area.

In further particularly preferred embodiments, the cell according to the disclosure is characterized by at least one of the immediately following features a. to c.:

a. The weight per unit area of the current collector in the main area is reduced by 5% to 80% compared to the weight per unit area of the current collector in the free edge strip.

b. The current collector has a hole area in the range of 5% to 80% in the main area.

c. The current collector has a tensile strength of 20 N/mm² to 250 N/mm² in the main area.

The hole area, often referred to as the free cross-section, can be determined according to ISO 7806-1983. The tensile strength of the current collector in the main area is reduced compared to current collectors without the apertures. Its determination can be done according to DIN EN ISO 527 part 3.

It is preferred that the anode current collector and the cathode current collector are identical or similar in terms of apertures. The respective achievable energy density improvements add up. In preferred embodiments, the cell according to the disclosure is therefore further characterized by at least one of the immediately following features a. to c.:

a. The strip-shaped main region of the anode current collector and the strip-shaped main region of the cathode current collector are both characterized by a plurality of the apertures.

b. The cell comprises the contact sheet metal member being in direct contact with one of the first longitudinal edges as the first contact sheet metal member, and further comprises a second contact sheet metal member being in direct contact with the other of the first longitudinal edges.

c. The second contact sheet metal member is connected to this other longitudinal edge by welding.

It is particularly preferred that the immediately preceding features a. to c. are realized in combination with each other. However, features b. and c. can also be implemented in combination without feature a.

The preferred embodiments of the current collector provided with the apertures described above are independently applicable to the anode current collector and the cathode current collector.

The use of perforated current collectors or current collectors otherwise provided with a plurality of apertures has not yet been seriously considered for lithium-ion cells, since it is very difficult to contact such current collectors electrically. As mentioned at the beginning, the electrical connection of the current collectors is often made via separate electrical conductor tabs. However, reliable welding of these conductor tabs to perforated current collectors in industrial mass production processes is difficult to realize without an acceptable error rate.

According to the present disclosure, this problem is solved by welding the current collector edges to the contact sheet metal member(s) as described. This concept makes it possible to completely dispense with separate conductor tabs, thus allowing the use of current collectors with a low material content and provided with apertures. In particular, in embodiments in which the free edge strips of the current collectors are not provided with apertures, welding can be performed reliably with exceptionally low rejection rates.

The concept of welding the edges of current collectors with contact sheet metal members is already known from WO 2017/215900 A1 or JP 2004-119330 A. The use of contact sheet metal members enables particularly high current carrying capacities and low internal resistance. Regarding contact sheet metal members that can be used according to the present disclosure and methods for electrically connecting contact sheet metal members to the edges of current collectors, full reference is therefore made to the contents of WO 2017/215900 A1 and JP 2004-119330 A.

If very thin metal foils are used as current collectors, the longitudinal edges of the current collectors can be extremely sensitive mechanically and can be unintentionally pressed down or melted down during welding with contact sheet metal members. Furthermore, melting of separators of the electrode-separator assembly can occur during welding of the contact sheet metal members. The support layer described above counteracts this.

The contact sheet metal members which are preferred for use in a cell according to the present disclosure may also be referred to as contact plates. In preferred embodiments, they are plate-shaped.

In some preferred embodiments, the cell according to the disclosure has at least one of the features a. and b. immediately below:

a. Sheet metal members, in particular metal plates, with a thickness in the range from 100 μm to 600 μm, preferably 150-350 μm, are used as contact sheet metal members.

b. The contact sheet metal members, especially the contact plates, consist of aluminum, titanium, nickel, stainless steel or nickel-plated steel.

The contact sheet metal members, in particular the contact plates, can have at least one slot and/or at least one perforation. These have the function of counteracting deformation of the contact sheet metal members, in particular the plates, during the production of the welded joint.

The contact sheet metal members may be in the form of strips, in particular strips of said thickness in the range from 100 μm to 600 μm, preferably from 150 to 350 μm, or comprise such a metal strip.

In preferred embodiments, contact sheet metal members, in particular contact plates, have the shape of a disk, in particular the shape of a circular or at least approximately circular disk. They then have an outer circular or at least approximately circular disk edge. In this context, an approximately circular disc is to be understood in particular as a disc which has the shape of a circle with at least one cut off circular segment, preferably with two to four cut off circular segments.

The insertable contact sheet metal members, in particular contact plates, can also have a polygonal, for example a rectangular, pentagonal or hexagonal base.

In cases with two contact sheet metal members, in particular with two contact plates, both contact sheet metal members, in particular both contact plates, are preferably electrically connected to a pole of the cell, for example a housing pole.

In particularly preferred embodiments, the anode current collector and the contact sheet metal member welded thereto, in particular the contact plate welded thereto, both consist of the same material. This is particularly preferably selected from the group comprising copper, nickel, titanium, nickel-plated steel and stainless steel.

In further particularly preferred embodiments, the cathode current collector and the contact sheet metal member welded thereto, in particular the contact plate welded thereto, both consist of the same material. This is particularly preferably selected from the group comprising aluminum, titanium and stainless steel (e.g. of type 1.4404).

In possible preferred further developments, the cell according to the disclosure is characterized by at least one of the immediately following features a. to c.:

a. The contact sheet metal member connected to the longitudinal edge of the anode current collector by welding, in particular the contact sheet metal plate connected to the longitudinal edge of the anode current collector by welding, is in contact with the longitudinal edge in such a way that a line-shaped contact zone results.

b. The contact sheet metal member connected to the longitudinal edge of the cathode current collector by welding, in particular the contact sheet metal plate connected to the longitudinal edge of the cathode current collector by welding, is in contact with the longitudinal edge in such a way that a line-shaped contact zone results.

c. The first longitudinal edge of the anode current collector and/or the cathode current collector comprises one or more sections, each of which is continuously connected over its entire length to the respective contact sheet metal member, in particular to the respective contact plate, by means of a weld seam.

The immediately preceding features a. and b. can be implemented both independently of each other and in combination. Preferably, however, features a. and b. are implemented in both cases in combination with the immediately preceding feature c.

Via the contact sheet metal members, it is possible to electrically contact the current collectors and thus also the associated electrodes over their entire length. This significantly reduces the internal resistance within the cell. The arrangement described can thus absorb the occurrence of large currents excellently. With minimized internal resistance, thermal losses at high currents are reduced. In addition, the dissipation of thermal energy from the wound electrode-separator assembly is favored. Under heavy loads, heating does not occur locally but is evenly distributed.

There are several ways in which the contact sheet metal members, especially the contact plates, can be connected to the longitudinal edges.

The contact sheet metal members, in particular the contact plates, may be joined to the longitudinal edges along the line-shaped contact zones by at least one weld seam. The longitudinal edges can thus comprise one or more sections, each of which is continuously connected to the contact sheet metal member(s), in particular the contact plate(s), over its entire length via a weld seam. Particularly preferably, these sections have a minimum length of 5 mm, preferably of 10 mm, especially preferably of 20 mm.

In a possible further development, the section or sections connected continuously to the contact sheet metal member, in particular the contact plate, extend over their entire length over at least 25%, preferably over at least 50%, particularly preferably over at least 75%, of the total length of the respective longitudinal edge.

In some preferred embodiments, the longitudinal edges are continuously welded to the contact sheet metal member, particularly the contact plate, over their entire length.

In further possible embodiments, the contact sheet metal members, in particular the contact plates, are connected to the respective longitudinal edge via a plurality or plurality of welding spots.

The electrode-separator assembly is preferably in the form of a spiral winding. As a result, the longitudinal edges of the anode current collector and the cathode current collector protruding from the terminal end faces of the winding also have a spiral geometry. The same applies to the line-shaped contact zone along which the contact sheet metal members, in particular the contact plates, are welded to the respective longitudinal edge.

When contact sheet metal members, in particular contact plates, are used, it is generally necessary to connect the contact sheet metal members, in particular the contact plates, electrically to the housing or to electrical conductors led out of the housing. For example, the contact sheet metal members, in particular the contact plates, can be connected to the housing parts mentioned directly or via electrical conductors for this purpose. Since the housing parts often serve as electrical poles of the cells, this is often even mandatory.

In a particularly preferred embodiment, the circular upper part and/or the circular lower part of the housing of the lithium-ion cell can serve as contact sheet metal members, in particular the contact plates. For example, it is possible for said circular lid, which serves to close the first housing part, to be welded as a contact sheet metal member, in particular as a contact plate, to one of the longitudinal edges of the anode current collector or the cathode current collector protruding from the terminal end faces of the winding. Similarly, it is conceivable to weld one of these longitudinal edges to the inner side of the bottom of the cup-shaped first housing part.

This embodiment can be particularly advantageous. On the one hand, it is optimal from a heat dissipation point of view. Heat generated within the winding can be dissipated directly to the housing via the longitudinal edges, in the case of welding along the line-shaped contact zone almost without any bottleneck. Secondly, the internal volume of a cell housing can be utilized almost optimally in this way. Separate contact sheet metal members, in particular separate contact plates, and electrical conductors for connecting the contact sheet metal members to the housing, require space inside cell housings. If such separate components are dispensed with, this space is available for active material. In this way, the energy density of cells can be further increased.

It should be emphasized that this embodiment can be realized completely independently of feature j. (j. the strip-shaped main region of the current collector connected to the contact sheet metal member by welding has a plurality of apertures). The disclosure thus also comprises cells in which the circular upper part and/or the circular lower part serve as a contact sheet metal member, in particular as a contact plate, but in which the current collectors do not necessarily have the plurality of apertures.

In further possible preferred further developments, the cell according to the disclosure is characterized by at least one of the immediately following features a. to c.:

a. The separator is a ribbon-shaped plastic substrate having a thickness in the range of 5 μm to 50 μm, preferably in the range of 7 μm to 12 μm, and having first and second longitudinal edges and two ends.

b. The longitudinal edges of the separator form the terminal end faces of the electrode-separator assembly.

c. The longitudinal edges of the anode current collector and/or the cathode current collector do not protrude from the terminal end faces of the winding more than 5000 μm, preferably not more than 3500 μm.

It is particularly preferred that the immediately preceding features a. to c. are realized in combination with each other.

Particularly preferably, the longitudinal edge of the anode current collector protrudes from the end face of the winding no more than 2500 μm, especially preferably no more than 1500 μm.

Particularly preferably, the longitudinal edge of the cathode current collector protrudes from the end face of the winding no more than 3500 μm, especially preferably no more than 2500 μm.

The figures for the end face projection of the anode current collector and/or the cathode current collector refer to the free projection before the end faces are brought into contact with the contact sheet metal member, in particular with the contact plate. During contacting and welding of the contact sheet metal member, in particular the contact plate, deformation of the edges of the current collectors may occur.

The smaller the free projection is selected, the wider the strip-shaped main regions of the current collectors covered with electrode material can be formed. This contributes positively to the energy density of the cell according to the disclosure.

Preferably, the ribbon-shaped anode and ribbon-shaped cathode are offset from each other within the electrode-separator assembly to ensure that the first longitudinal edge of the anode current collector protrudes from one of the terminal end faces and the first longitudinal edge of the cathode current collector protrudes from the other of the terminal end faces.

The lithium-ion cell according to the disclosure may be a button cell. Button cells are cylindrical in shape and have a height that is less than their diameter. Preferably, the height is in the range of 4 mm to 15 mm. It is further preferred that the button cell has a diameter in the range from 5 mm to 25 mm. Button cells are suitable, for example, for supplying electrical energy to small electronic devices such as watches, hearing aids and wireless headphones.

The nominal capacity of a lithium-ion cell in the form of a button cell according to the disclosure can generally be up to 1500 mAh. Preferably, the nominal capacity is in the range from 100 mAh to 1000 mAh, particularly preferably in the range from 100 to 800 mAh.

Particularly preferably, the lithium-ion cell according to the disclosure is a cylindrical round cell. Cylindrical round cells have a height that is greater than their diameter. They are particularly suitable for applications in the automotive sector, for e-bikes or also for other applications with high energy requirements.

Preferably, the height of lithium-ion cells designed as round cells is in the range of 15 mm to 150 mm. The diameter of the cylindrical round cells is preferably in the range of 10 mm to 60 mm. Within these ranges, form factors of, for example, 18×65 (diameter*height in mm) or 21×70 (diameter*height in mm) are particularly preferred. Cylindrical round cells with these form factors are particularly suitable for supplying power to electric drives in motor vehicles.

The nominal capacity of a lithium-ion cell according to the disclosure, which is designed as a cylindrical round cell, can preferably be up to 90000 mAh. With the form factor of 21×70, the cell in one embodiment as a lithium-ion cell preferably has a nominal capacity in the range from 1500 mAh to 7000 mAh, particularly preferably in the range from 3000 to 5500 mAh. With the form factor of 18×65, the cell in one embodiment as a lithium-ion cell preferably has a nominal capacity in the range of 1000 mAh to 5000 mAh, particularly preferably in the range of 2000 to 4000 mAh.

In the European Union, manufacturers are strictly regulated in providing information on the nominal capacities of secondary batteries. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard, and information on the nominal capacity of secondary lead-acid batteries must be based on measurements according to the IEC/EN 61056-1 standard. Any information on nominal capacities in the present disclosure is preferably also based on these standards.

The anode current collector, the cathode current collector and the separator preferably have the following dimensions in embodiments in which the cell according to the disclosure is a cylindrical round cell:

A length in the range from 0.5 m to 25 m

A width in the range 30 mm to 145 mm

In these cases, the free edge strip extending along the first longitudinal edge, which is not loaded with the electrode material, preferably has a width of no more than 5000 μm.

In the case of a cylindrical round cell with the form factor 18×65, the current collectors preferably have

a width of 56 mm to 62 mm, preferably 60 mm, and

a length of not more than 1.5 m.

In the case of a cylindrical round cell with the form factor 21×70, the current collectors preferably have

a width of 56 mm to 68 mm, preferably 65 mm, and

a length of not more than 2.5 m.

The above-described design of the cell according to the disclosure enables yet another significant advantage. In the case of electrodes in which the current collectors are electrically connected via the separate conductor tabs mentioned at the beginning, a greater thermo-mechanical load occurs during charging and discharging in the immediate vicinity of the conductor tabs than away from the conductor tabs. This difference is particularly pronounced in the case of negative electrodes which have a proportion of silicon, tin and/or antimony as active material, since particles made of these materials are subject to comparatively strong volume changes during charging and discharging. For example, proportions of more than 10% silicon in negative electrodes have therefore proved difficult to control to date.

The electrical connection of the current collector(s) via contact sheet metal members, in particular via contact plates, not only enables said uniform heat dissipation of cells, but also distributes the thermo-mechanical loads occurring during charging and discharging evenly over the winding. Surprisingly, this makes it possible to control very high proportions of silicon and/or tin and/or antimony in the negative electrode; at proportions >20%, comparatively rare or no damage was observed during charging and discharging as a result of the thermomechanical loads. By increasing the proportion of silicon in the anode, for example, the energy density of the cell can also be further increased.

Accordingly, in particularly preferred embodiments, the cell according to the disclosure is characterized by the immediately following feature a:

a. The negative electrode material comprises as negative active material silicon, aluminum, tin and/or antimony, in particular particulate silicon, aluminum, tin and/or antimony, in a proportion of 20 wt. % to 90 wt. %.

The weights given here refer to the dry mass of the negative electrode material, i.e. without electrolyte and without taking into account the weight of the anode current collector.

It should be emphasized that this embodiment can also be realized completely independently of feature j. (j. the strip-shaped main region of the current collector connected to the contact sheet metal member by welding has a plurality of apertures). The disclosure thus also comprises cells in which the anode in the charged state comprises particulate silicon in a proportion of 20% to 90% by weight, but in which the current collectors do not necessarily have the plurality of apertures.

Of the active materials silicon, aluminum, tin and antimony, silicon is particularly preferred.

The skilled person understands that the tin, aluminum, silicon and antimony do not necessarily have to be metals in their purest form. For example, silicon particles may also contain traces of other elements, in particular other metals (apart from lithium), for example in proportions of up to 10% by weight.

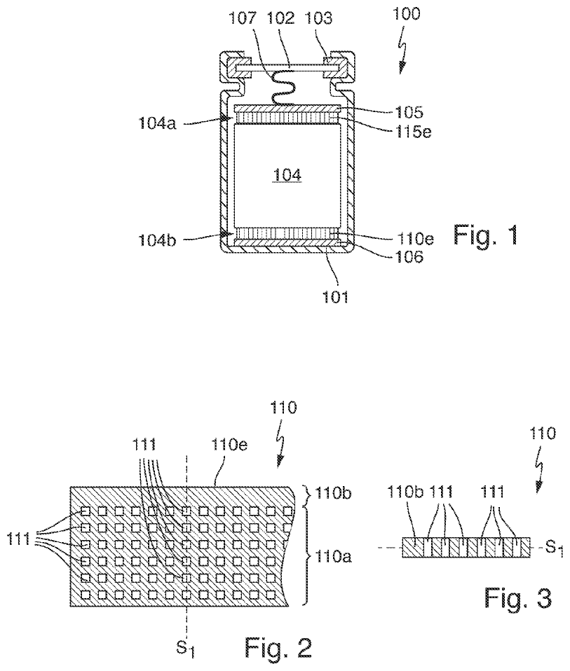

The lithium-ion cell 100 shown in FIG. 1 comprises a housing consisting of the cup-shaped housing part 101 and the disk-shaped housing part 102. The two housing parts (101; 102) are separated from each other by the seal 103. Inside the housing, the electrode-separator assembly 104 is arranged in the form of a spiral winding having end faces 104a and 104b. The electrode-separator assembly 104 comprises a spirally wound anode and a spirally wound cathode, each having a ribbon-shaped metal foil as a current collector (not shown separately in FIG. 1). The electrodes are offset from each other within the composite 104 so that a longitudinal edge 110e of the current collector of the anode protrudes from one of the end faces 104a and 104b, and a longitudinal edge 115e of the current collector of the cathode protrudes from the other of the end faces. The cell 100 comprises two metallic contact plates 105 and 106 that are in direct contact with and welded to the longitudinal edges 110e and 115e. The contact plate 105 is connected to the housing part 102 via the electrical conductor 107. The contact plate 106 is welded directly to the bottom of the cup-shaped housing part 101.

FIG. 2 and FIG. 3 illustrate the design of a current collector 110 that can be used in the cell shown in FIG. 1. FIG. 3 is a sectional view along S₁. The current collector 110 comprises a plurality of apertures 111, which are rectangular holes. The region 110a is characterized by the apertures 111, whereas no apertures are found in the region 110b along the longitudinal edge 110e. Therefore, the current collector 110 has a significantly lower weight per unit area in the area 110a than in the area 110b.

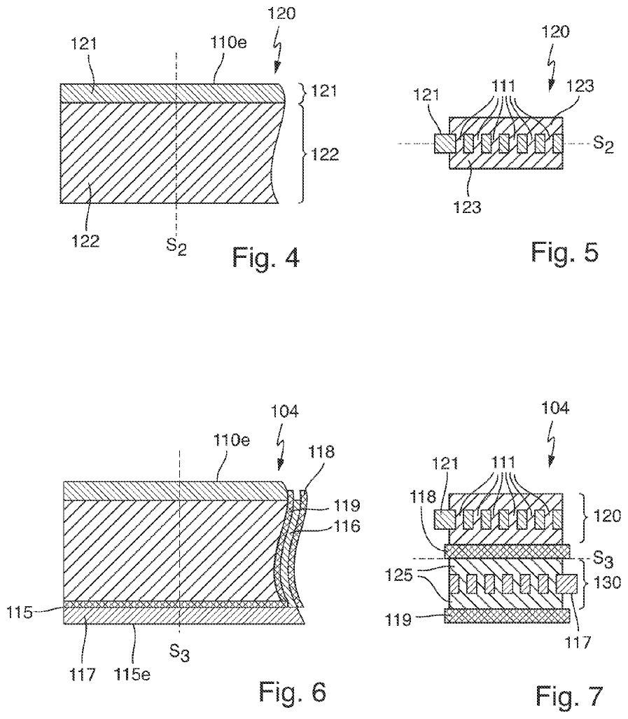

FIG. 4 and FIG. 5 illustrate an anode 120 fabricated by applying a negative electrode material 123 to both sides of the current collector 110 shown in FIG. 2 and FIG. 3. FIG. 5 is a sectional view along S₂. The current collector 110 now has a strip-shaped main region 122 loaded with a layer of the negative electrode material 123, and a free edge strip 121 extending along the longitudinal edge 110e that is not loaded with the electrode material 123. Furthermore, the electrode material 123 also fills the apertures 111.

FIG. 6 and FIG. 7 illustrate an electrode-separator assembly 104 fabricated using the anode 120 shown in FIG. 4 and FIG. 5. In addition, it comprises the cathode 115 and the separators 118 and 119. FIG. 7 is a sectional view along S₃. The cathode 115 builds on the same current collector design as the anode 120. Preferably, the current collectors 110 and 115 of anode 120 and cathode 130 differ only in their respective material choices. For example, the current collector 115 of cathode 130 comprises a strip-shaped main region 116 loaded with a layer of positive electrode material 125, and a free edge strip 117 extending along longitudinal edge 115e that is not loaded with electrode material 125. By spirally winding the electrode-separator assembly 104 it can be transformed into a winding suitable for a cell according to the disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A lithium ion cell, comprising:
a ribbon-shaped electrode-separator assembly comprising an anode, a separator, and a cathode in a sequence anode separator/cathode, the electrode-separator assembly being formed as a winding with two terminal end faces, wherein:
the anode comprises, as an anode current collector, a ribbon-shaped metal foil having a thickness in a range of 4 μm to 30 μm, a first longitudinal edge, a second longitudinal edge, and two ends,
the anode current collector has a strip-shaped main region loaded with a layer of negative electrode material and a free edge strip extending along the first longitudinal edge that is not loaded with the negative electrode material,
the cathode comprises, as a cathode current collector, a ribbon-shaped metal foil having a thickness in a range of 4 μm to 30 μm, a first longitudinal edge, a second longitudinal edge, and two ends,
the cathode current collector has a strip-shaped main region loaded with a layer of positive electrode material and a free edge strip extending along the first longitudinal edge that is not loaded with the positive electrode material,
the anode and the cathode are formed and/or arranged relative to each other within the electrode-separator assembly such that the first longitudinal edge of the anode current collector protrudes from one of the terminal end faces of the winding-and the first longitudinal edge of the cathode current collector protrudes from the other of the terminal end faces of the winding; and
a contact sheet metal member in direct contact with a respective longitudinal edge, the respective longitudinal edge being the first longitudinal edge of the anode current collector or the first longitudinal edge of the cathode current collector, the contact sheet metal member being connected to the respective longitudinal edge by welding,
wherein the strip-shaped main region of the current collector connected to the contact sheet metal member by welding has a plurality of apertures.

2. The cell of claim 1, wherein
the plurality of apertures are round or square holes, and/or
the plurality of apertures are formed as round hole or slotted hole perforations.

3. The cell according to claim 1, wherein the apertures have an average diameter in a range of 1 μm to 2000 μm.

4. The cell according to claim 1, wherein
at least a partial section of the main area of e current collector connected to the contact sheet metal member by welding has a lower weight per unit area than the free edge strip of the current collector connected to the contact sheet metal member by welding, and/or
the free edge strip of the current collector connected to the contact sheet metal member by welding has no or fewer apertures per unit area than the main area of the current collector connected to the contact sheet metal member by welding.

5. The cell according to claim 1, wherein at least one feature is present from the group of features consisting of:
the weight per unit area, in the main area, of the current collector connected to the contact sheet metal member by welding is reduced by 5% to 80% compared to the weight per unit area, in the free edge strip, of the current collector connected to the contact sheet metal member by welding,
the current collector connected to the contact sheet metal member by welding has a hole area in a range of 5% to 80% in the main area,
the current collector connected to the contact sheet metal member by welding has a tensile strength of 20 N/mm2 to 250 N/mm2 in the main area.

6. The cell according to claim 1, wherein:
the strip-shaped main region of the anode current collector and the strip-shaped main region of the cathode current collector both have a plurality of apertures,
the cell further comprises a second contact sheet metal member being in direct contact with another respective longitudinal edge, the another respective longitudinal edge being the other of the first longitudinal edge of the anode current collector or the first longitudinal edge of the cathode current collector to which the contact sheet metal member is not in direct contact with, and
the second contact sheet metal member is connected to the another longitudinal edge by welding.

7. The cell according to claim 6, wherein at least one feature is present from the group of features consisting of:
the contact sheet metal member connected to the first longitudinal edge of the anode current collector by welding is in contact with the first longitudinal edge of the anode current collector such that a line-shaped contact zone is formed,
the contact sheet metal member connected to the first longitudinal edge of the cathode current collector by welding is in contact with the first longitudinal edge of the cathode current collector such that a line-shaped contact zone results,
the first longitudinal edge of the anode current collector and/or the first longitudinal edge of the cathode current collector comprises one or more sections, each of which is continuously connected to a respective contact sheet metal member along its entire length by a weld seam.

8. The cell according to claim 1, wherein at least one feature is present from the group of features consisting of:
the separator is a ribbon-shaped plastic substrate comprising a thickness in a range of 5 μm to 50 μm, first and second longitudinal edges, and two ends,
the first and second longitudinal edges of the separator form the terminal end faces of the winding, and
the first longitudinal edge of the anode current collector and/or the first longitudinal edge of the cathode current collector protrude from the terminal end faces of the winding by 5000 μm or less.
